(19) United States
(12) Patent Application Publication
(10) Pub. No.: US 2026/0241734 A1
(43) Pub. Date: Aug. 20, 2026

(54) INKJET PRINTING METHOD AND INKJET PRINTING APPARATUS

(71) Applicant: UNIJET CO., LTD., Gyeonggi-do (KR)

(72) Inventors: HEE JUN HAN, Gyeonggi-do (KR); SEOG SOON KIM, Gyeonggi-do (KR); GIL HWAN YEO, Gyeonggi-do (KR)

(21) Appl. No.: 18/724,801

(22) PCT Filed: Oct. 17, 2022
(86) PCT No.: PCT/KR2022/015678

§ 371 Date: Jun. 27, 2024

(30) Foreign Application Priority Data
Dec. 30, 2021 (KR) 10-2021-0192066

(51) Int. Cl. B41M 3/00; B41J 3/54; B41J 11/00; B41J 13/00; B41M 7/00

(52) U.S. Cl. CPC B41M 3/008; B41J 3/543; B41J 11/00214; B41J 11/008; B41J 13/0027; B41M 7/0081

(57) ABSTRACT

A method for forming a thick film layer having a thickness (t=t1+t2) on a substrate by using an ink jet printing apparatus including a head module for discharging ink, includes a first printing step of forming a thin film printing layer having a thickness (t1) on a substrate by discharging ink in an amount in which a thin film coating of uniform thickness can be printed by attraction of ink droplets that land on the substrate to each other, and a second printing step of forming a thick film printing layer having a thickness (t2=t−t1) by discharging an ink in an amount in which a thick film coating having a uniform thickness can be printed by overlapping on the thin film printing layer.

### CROSS REFERENCE TO RELATED APPLICATIONS AND CLAIM OF PRIORITY

This application claims benefit under 35 U.S.C. 119, 120, 121, or 365 (c), and is a National Stage entry from International Application No. PCT/KR2022/015678 filed on Oct. 17, 2022, which claims priority to the benefit of Korean Patent Application No. 10-2021-0192066 filed on Dec. 30, 2021, in the Korean Intellectual Property Office, the entire contents of which are incorporated herein by reference.

### STATEMENT REGARDING FEDERALLY SPONSORED RESEARCH OR DEVELOPMENT

The present invention was supported by the national research and development program (Project identification number: 1415172481; Project number: 20010442; Government department name: Ministry of Trade, Industry and Energy; Project management (professional); institution name: Korea Planning & Evaluation Institute of Industrial Technology; Research project title: Materials and parts industry future growth engines (R&D); Research title: Technology development for display-integrated 28 GHz to 5G millimeter-wave antenna for mobile display; Contribution ratio: 1/1; Project performing organization name: UNIJET CO., LTD. ; Research period: Apr. 1, 2020 to Dec. 31, 2023)

### BACKGROUND

### 1. Technical Field

The present development technology relates to a technique for controlling an ejection stain inside one inkjet head and a stain generated between in inkjet heads in a printing process using an inkjet printing technique.

### 2. Background Art

Recently, development for high performance displays to improve performance and quality of Smartphones due to development such as fourth industrial revolution is ongoing.

A high performance display is provided so that a cover window, a polarizer, a touch sensor panel, and the like are disposed on a top surface of the display, and in order to attach these components and improve optical characteristics of an adhesive, an optically clear adhesive (OCA) or an optically clear resin (OCR), each of which is a transparent adhesive, is used.

The OCA is provided in the form of a solid film, and the OCR is formed in a liquid state.

The OCA is supplied in a standardized size varying depending on a product, with protective films attached to both surfaces thereof, and is used as an adhesive material for bonding components such as a display panel, a window, a touch sensor panel, and a polarizer.

An OCA film has an advantage of being easily handleable in a manufacturing process, but has a disadvantage that as a standardized product is used for one product, when a display product is changed, the OCA film needs to be changed accordingly.

In addition, in a case in which there is a stepped portion of an attachment substrate, an ability to fill the stepped portion may be low due to the characteristic of the solidified adhesive, and a bubble defect may be generated when a foreign matter is introduced. Here, in an optical portion, a fine bubble may be difficult to completely remove to result in a reduction in transmittance.

OCA products have disadvantages that in a small thickness of about 20 μm or less, thickness uniformity is difficult to satisfy, and a probability of failure to detach protective films is high in a process of manufacturing displays to be disadvantageous in application to the display process.

The OCR is a material replacing the OCA, and is an adhesive material that is printed on a substrate in a liquid state and cured to be bonded to another substrate.

Thus, the OCR is used as an adhesive that bonds components variously stacked at the same position as a layer to which the OCA is applied in a display product. For example, the OCR is applied between various layers such as a cover window and a touch sensor panel, a cover window and a display panel, a touch sensor panel and a display panel, a display rear surface and a heating plate, and a heating plate and a buffer.

In the OCA film described above, outer edges thereof are cut, and thus straightness and uniformity of a film thickness is easy to maintain. However, OCR printing has disadvantages that as an ink is spread to the outside on an edge of a printing film, a final thickness may be formed to be less than a desired thickness, and straightness at the edge of the printing film is lower than that of the OCA.

And a coating method for the OCR may be classified into a slit method and an inkjet method.

The slit coating method is disadvantageous in terms of slit component management and usage when compared to the inkjet method, and the inkjet method has constraints on use according to the viscosity of an OCR material to be used and inkjet head characteristics when compared to the slit method.

In the inkjet printing technique, as one head has a restricted width, the one head may perform printing on a large substrate while reciprocating multiple times. However, there is a problem that the productivity deteriorates due to an increase in printing time according to multiple reciprocal printing operations.

In order to solve the problem, when printing is performed on a substrate having a large width by using a plurality of inkjet heads as illustrated in FIG. 1, the plurality of inkjet heads may be arranged to overlap each other in a head longitudinal direction so that an area having a greater width than the inkjet head at once is printed by one-time printing.

In addition, in a case in which a printing thickness is large, for example, a thickness of 100 μm or more, when a plurality of inkjet head columns are installed to overlap each other on the same printing line, an ink may be applied as much as the number of the inkjet heads so that a thickness larger than a thickness resulting from printing using one inkjet head is printed even by one-time printing.

Thus, in a case in which large-area and large-thickness printing is performed, when several inkjet heads are mounted in each of a longitudinal direction and a printing direction to perform the printing, one-time printing enables the large-area and large-thickness printing.

Meanwhile, in order that deposited ink drops are allowed to remain at dropped positions to achieve uniform coating in a large thickness with one printing operation, a light emitting unit may be mounted behind an inkjet head module so that the ink drops are immediately temporarily cured during coating.

In addition, it is inevitable that an actual printing width by the inkjet head is much less than an actual head width because, in respective structures of almost all the inkjet heads, an ink supply channel structure, which supplies an ink to a head, and a structure for fixing the head are installed at both side surfaces of the head, and head nozzles are disposed at a central portion of the head.

Even for this reason, when the plurality of inkjet heads are connected and arranged in the longitudinal direction, heads have to overlap in two rows at the front and the rear due to mechanism limitations. That is, when the heads are arranged in the longitudinal direction for a surface to be printed not to be exposed, the heads have to be misaligned apart by a head thickness in two rows.

This results in an arrangement in which a difference between nozzle positions of the heads disposed in the front row and the rear row occurs as much as the head width.

This leads to a time difference between ink drops to be printed at a boundary between the heads, and an ink drop first deposited in the front row attracts an ink drop later deposited in the rear row to cause ink gathering. Accordingly, as illustrated in FIG. 2, a difference in thickness occurs to constitute one cause of occurrence a stain.

As a method for solving this problem, there are also heads designed to be continuously connected in one row in a head longitudinal direction as the heads having a rhombus shape have each a central portion at which nozzles in 32 rows are arranged as illustrated in FIG. 3.

When this head is applied, nozzles may cover the entire surface thoroughly to perform printing, even when heads are arranged in one row in printing a region having a greater size than one head.

Thus, the application of heads in which this rhombus shaped head is developed helps reduce stains between the heads which are generated because of the head positions.

However, as a size of the ink drop of this head is restricted, one-time printing in arrangement of heads in one row has a limit to coating in a large thickness.

In addition, nozzle columns inside this head are 32 and there is a big difference between respective positions of the nozzles in a printing direction. Thus, there is a similar problem to that of two-row arrangement of general heads.

Meanwhile, when a plasma process is performed on a substrate surface to be printed in order to improve bonding with the substrate before the inkjet printing, hydrophilicity is improved to improve spreadability of ink drops on the substrate. Due to this spreadability, the ink drops are spread more widely by being seated on the substrate immediately after being discharged from the inkjet head.

The continuously discharged drops are also seated on the substrate, and combined with the previously discharged drops while spreading. Some of respective shapes of the ink drops are maintained immediately after the ink drops are gathered, and as time passes, the gathered ink drops are leveled so that the thickness is uniform.

Meanwhile, as illustrated in FIG. 4, with the ink drops spreading, the ink drops are spread to a wider area than a targeted printing area on an edge of a printing layer of a substrate 100, and this leads to a phenomenon in which the thickness is gently decreased.

In order to compensate for the problem caused by this thickness difference during a bonding process, i.e., to compensate for the decrease in ink thickness at an outer part, an additional printing process may be performed only on the edge so that the height of the edge is increased.

However, printing for a large thickness has a disadvantage that a separate printing process is required to print this edge in a large thickness.

For example, as illustrated in FIG. 5, also in a camera hole inside a display screen of a display, as the hole has been penetrated through a laser process, the printing is performed only to a position adjacent to the hole.

As there is the ink spreading phenomenon also at the position adjacent to the hole, there is a problem that processing costs, time and effort are required to form a large thickness through separate additional printing.

### SUMMARY

The objective of the present invention is to provide an inkjet printing method capable of preventing stains from being generated by improving thickness uniformity while achieving a large thickness intended when a thick film layer having a large thickness is printed by the inkjet printing method.

In order to solve the above problems, a method for forming a thick film layer having a thickness (t=t1+t2) on a substrate by using an ink jet printing apparatus including a head module for discharging ink, includes: first printing step (s10) of forming a thin film printing layer having a thickness (t1) on the substrate by discharging an ink in an amount to allow ink droplets deposited on the substrate to overlap and attract each other to print a thin film coating having a uniform thickness ; and a second printing step (s20) of forming a thick film printing layer having a thickness (t2=t−t1) by discharging an ink in an amount in which a thick film coating having a uniform thickness is printed to overlap on the thin film printing layer. An initial microstructure is induced as martensites having a fine layered structure, and then a nanocrystalline titanium alloy is prepared at low strain by optimizing process variables through observation of the effects of strain, strain rate, and deformation temperature on the changes in the microstructure.

In the inkjet printing method according to the present invention, the second printing step (s20) is performed after a time period of leveling the ink droplets discharged in the first printing step (s10).

In the inkjet printing method according to the present invention, the first printing step (s10) is performed while the substrate relatively moves in one direction of a substrate printing direction, and the second printing step (s10) is performed while the substrate relatively moves in an opposite direction to the one direction of the substrate printing direction.

The inkjet printing method according to the present invention further includes an ink curing step (s30) of curing the printed ink, and the ink curing step (s30) includes: a thin film printing layer curing step (s31) of curing the thin film printing layer at a front side in the substrate printing direction in the first printing step (s30); and a thick film printing layer curing step (s32) of curing the thick film printing layer at a rear side in the substrate printing direction in the first printing step (s30).

In the inkjet printing method according to the present invention, in the thick film printing layer curing step (s32), at least an edge portion of the thick film printing layer is cured to prevent non-uniform ink spreading on an edge of the thick film printing layer when the second printing step (s20) is performed.

In the inkjet printing method according to the present invention, the first printing step (s10) and the second printing step (s20) are performed at positions spaced apart from each other in the substrate printing direction.

The inkjet printing method according to the present invention further includes an ink curing step (s30), and the ink curing step (s30) includes: a thin film printing layer curing step (s31) of curing the thin film printing layer at a front side in the substrate printing direction in the first printing step (s30); and a thick film printing layer curing step (s32) of curing the thick film printing layer at the front side in the substrate printing direction in the second printing step (s30).

In the inkjet printing method according to the present invention, in the thick film printing layer curing step (s32), at least an edge portion of a printing region is cured to prevent non-uniform ink spreading on an edge of the thick film printing layer during the printing in the second printing step (s20).

The inkjet printing method according to the present invention further includes an ink curing step (s30) of curing the printed ink at the rear side in the substrate printing direction in the second printing step (s20).

In the inkjet printing method according to the present invention, a size of each of the ink droplets in the second printing step (s20) is greater than or equal to a size of each of the ink droplets in the first printing step (s10).

In the inkjet printing method according to the present invention, a plurality of ink droplets are discharged by one signal at the same time or continuously in the second printing step (s20) so that the ink is discharged in an amount greater than an amount of the ink discharged in the first printing step (s30).

In the inkjet printing method according to the present invention, the ink applied in the second printing step (s20) is the same ink or an ink having the same surface tension as the ink applied in the first printing step (s10).

In the inkjet printing method according to the present invention, only the second printing step (s20) is additionally performed to increase the thickness (t) of the thick film layer.

In the inkjet printing method according to the present invention, the thickness (t1) of the thin film printing layer in the first printing step (s10) is 0.08 t to 0.3 t, and the thickness (t−t1) of the thick film layer in the second printing step (s20) is 0.992 t to 0.7 t.

An inkjet printing method according to the present invention is an inkjet printing apparatus for providing a thick film layer having a thickness (t=t1+t2) on a substrate, the inkjet printing apparatus including: a head array module installed above the substrate to discharge an ink on the substrate, wherein the head array module is arranged in a direction perpendicular to a substrate printing direction, and provided so that a plurality of heads overlap each other to form an array in the substrate printing direction, wherein the inkjet printing apparatus performs: a first printing step of forming a thin film printing layer having a thickness (t1) on the substrate by discharging an ink in an amount in which ink droplets, which are sprayed from the head array module to be deposited on the substrate while the substrate moves relative to the head array module in the substrate printing direction, attract each other so as to print a thin film coating having a uniform thickness; and a second printing step of forming a thick film printing layer having a thickness (t2=t−t1) by allowing the head array module to discharge an ink in an amount to print a thick film coating having a uniform thickness to overlap on the thin film printing layer, while the substrate moves relative to the head array module in a direction opposite to the substrate printing direction.

The inkjet printing method according to the present invention further includes a substrate transfer device which controls a transfer speed of the substrate so that the second printing step is performed after leveling of the ink discharged in the first printing step is completed.

The inkjet printing method according to the present invention further includes a head array module transfer device which controls a transfer speed of the head array module so that the second printing step is performed after leveling of the ink discharged in the first printing step is completed.

The inkjet printing method according to the present invention further includes a curing module that cures the thick film layer, wherein the curing module includes: a first curing module installed in front of the head array module in the substrate printing direction to cure the thin film printing layer; and a second curing module installed behind the head array module in the substrate printing direction to cure the thick film printing layer, wherein the first and second curing modules are provided to move simultaneously with the head array module forward and backward in the substrate printing direction by the substrate transfer device.

The inkjet printing method according to the present invention further includes a curing module that cures the thick film layer, wherein the curing module includes: a first curing module installed in front of the head array module in the substrate printing direction to cure the thin film printing layer; and a second curing module installed behind the head array module in the substrate printing direction to cure the thick film printing layer, wherein the inkjet printing apparatus includes first and second curing module transfer devices which are installed to be, respectively, connected to the first curing module and the second curing module to transfer the first and second curing modules forward and backward in the substrate printing direction separately from the substrate transfer module.

An inkjet printing apparatus according to the present invention is an inkjet printing apparatus for providing a thick film layer having a thickness (t=t1+t2) on a substrate, the inkjet printing apparatus including: two head array modules, each of which is installed above the substrate to discharge an ink on the substrate, wherein the head array modules are arranged in a direction perpendicular to a substrate printing direction, and provided so that a plurality of heads overlap each other to form an array in the substrate printing direction, wherein the head array modules include a first head array module installed at a rear side in the substrate printing direction, and a second head array module installed behind the first head array module in the substrate printing direction, wherein the inkjet printing apparatus performs: a first printing step of forming a thin film printing layer having a thickness (t1) on the substrate by discharging an ink in an amount to allow ink droplets, which are sprayed from the first head array module to be deposited on the substrate while the substrate moves relative to the head array module in the substrate printing direction, to attract each other to print a thin film coating having a uniform thickness; and a second printing step of forming a thick film printing layer having a thickness (t2=t−t1) on the substrate by discharging an ink in an amount to allow the second head array module to overlap on the thin film printing layer to print a thick film coating having a uniform thickness.

The inkjet printing method according to the present invention further includes a substrate transfer device which controls a transfer speed of the substrate so that the second printing step is performed after leveling of the ink discharged in the first printing step is completed.

The inkjet printing method according to the present invention further includes first and second head array module transfer devices which are installed to be, respectively, connected to the first head array module and the second head array module to transfer the first and second head array modules forward and backward in the substrate printing direction, wherein the second head array module transfer device adjusts a relative transfer speed of the second head array module to the first head array module so that the second printing step is performed after leveling of the ink discharged in the first printing step is completed.

In the inkjet printing method according to the present invention, a distance between the first head array module and the second first head array module is set so that the second printing step starts when a time period of leveling the ink is completed after the first printing is finished at a transfer speed of the substrate transfer device (101).

The inkjet printing method according to the present invention further includes a curing module which cures the thick film layer, wherein the curing module includes a first curing module installed behind the first head array module in the substrate printing direction to cure the thin film printing layer, and a second curing module installed behind the second head array module in the substrate printing direction to cure the thick film printing layer, wherein the first head array module and the first curing module are provided to be moved by the first head array module transfer device forward and backward in the substrate printing direction, and the second head array module and the second curing module are provided to be moved by the second head array module transfer device forward and backward in the substrate printing direction.

The inkjet printing method according to the present invention further includes a curing module which cures the thick film layer, wherein the curing module includes: a first curing module installed behind the first head array module in the substrate printing direction to cure the thin film printing layer, and a second curing module installed behind the second head array module in the substrate printing direction to cure the thick film printing layer, wherein the inkjet printing apparatus comprises first and second curing module transfer devices which are installed to be, respectively, connected to the first curing module and the second curing module to transfer the first and second curing modules forward and backward in the substrate printing direction separately from the first and second substrate transfer devices.

The inkjet printing method according to the present invention further includes a curing module which cures the thick film layer, wherein the curing module is installed behind the second head array module in the substrate printing direction, wherein the curing module and the second head array module are provided to be moved forward and backward in the substrate printing direction by the second head array module transfer device.

The inkjet printing method according to the present invention further includes a curing module which cures the thick film layer, wherein the curing module is installed behind the second head array module in the substrate printing direction, and is installed to be connected to the curing module to transfer the curing module forward and backward in the substrate printing direction separately from the first and second substrate transfer devices.

The present invention operates so that the first printing is performed on the entirety surface in the small thickness, and then the second printing is performed or the inkjet printing is performed multiple times to form the targeted thickness.

Accordingly, even in the printing process in which the several inkjet heads are used to rapidly form the thick film having the large thickness on the large area, the printing smear generated due to the deviation and position difference between the inkjet heads, the deviation between the nozzles, and the difference in surface state of the substrate is removed to have the effect of improving the display quality.

In addition, there is the advantage that the additional process for the increase in height of the edge is not performed to prevent the edge spreading unlike the related art.

The thick film layer having the targeted large thickness as above and also having the uniform thickness may be utilized as the buffer, the hard coating agent of the cover window, the protective film of the bending area, or the like, in addition to the OCR of the display product.

### BRIEF DESCRIPTION OF THE DRAWINGS

FIG. 1 is a view illustrating a head array of an inkjet printing apparatus according to the related art.

FIG. 2 is a view illustrating a phenomenon in which stains occur when printing is performed using an inkjet printing apparatus according to the related art.

FIG. 3 is a view illustrating a configuration of a head having a rhombus shape according to the related art.

FIG. 4 is a view illustrating an ink spreading phenomenon on an edge of a printing region according to the related art.

FIG. 5 is a view illustrating an ink spreading phenomenon on an edge of a smartphone camera hole according to the related art.

FIG. 6 is a view illustrating a reciprocating printing type of an inkjet printing apparatus according to an embodiment of the present invention.

FIG. 7 is a view illustrating an embodiment in which a curing module is separately driven in FIG. 6.

FIG. 8 is a view illustrating a unidirectional printing type of an inkjet printing apparatus according to an embodiment of the present invention.

FIG. 9 is a view illustrating an embodiment in which a curing module is separately driven in FIG. 8.

FIG. 10 is a view illustrating a unidirectional printing type of an inkjet printing apparatus according to another embodiment of the present invention.

FIG. 11 is a view illustrating an embodiment in which a curing module is separately driven in FIG. 10.

FIG. 12 is a view illustrating a first printing step of an inkjet printing method according to the present invention.

FIG. 13 is a view illustrating a second printing step of an inkjet printing method according to the present invention.

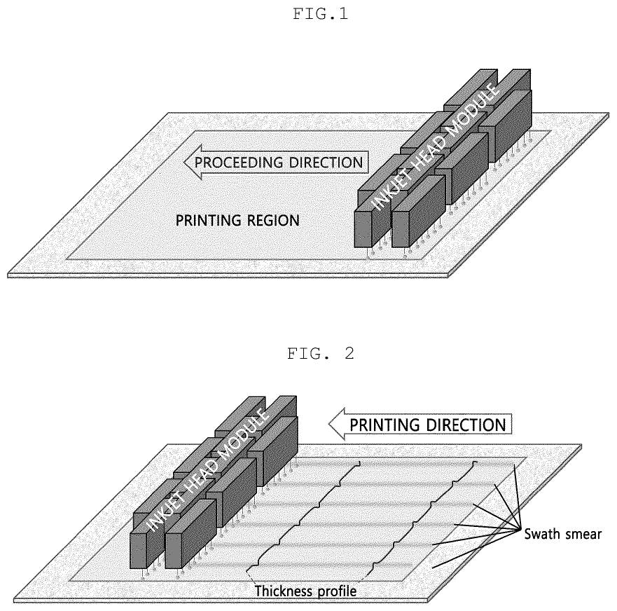

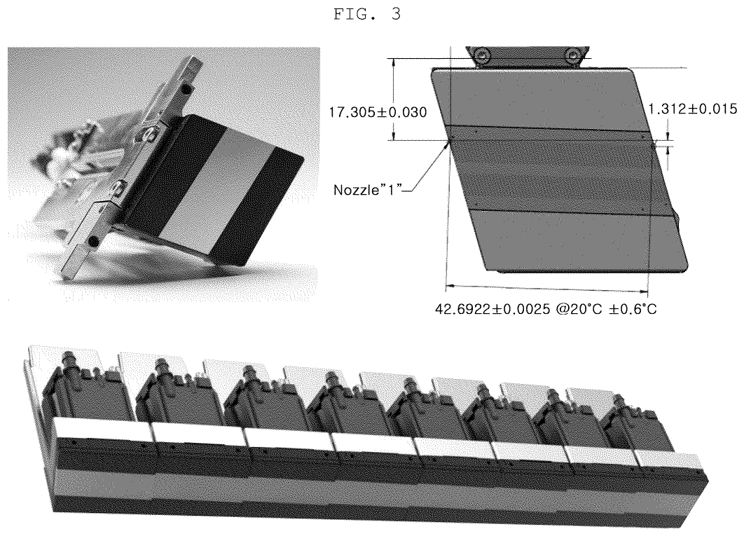

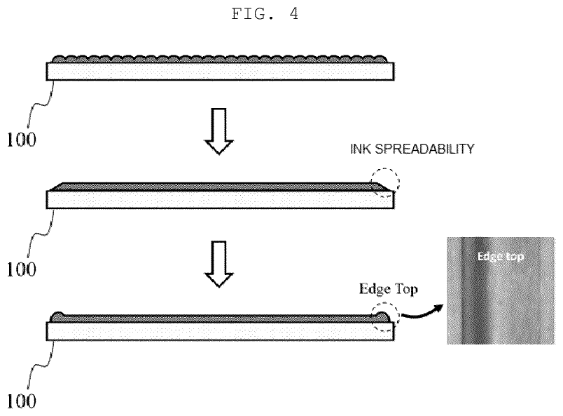

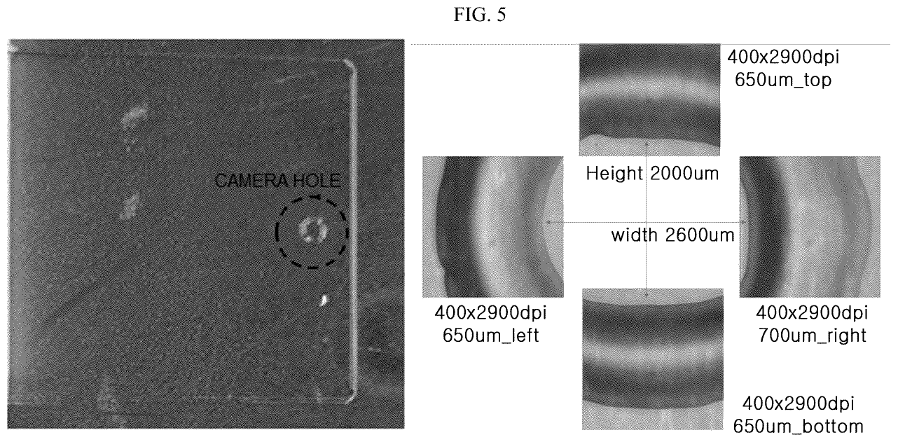

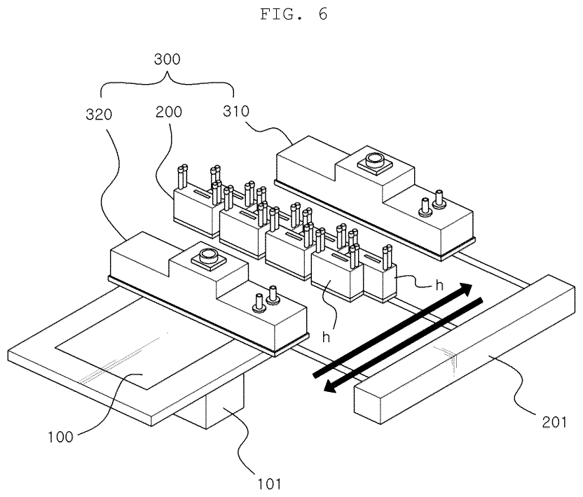

### DETAILED DESCRIPTION

Hereinafter, embodiments of the present invention will be described with reference to the drawings. Hereinafter, the present invention will be described in detail.

### Inkjet Printing Apparatus

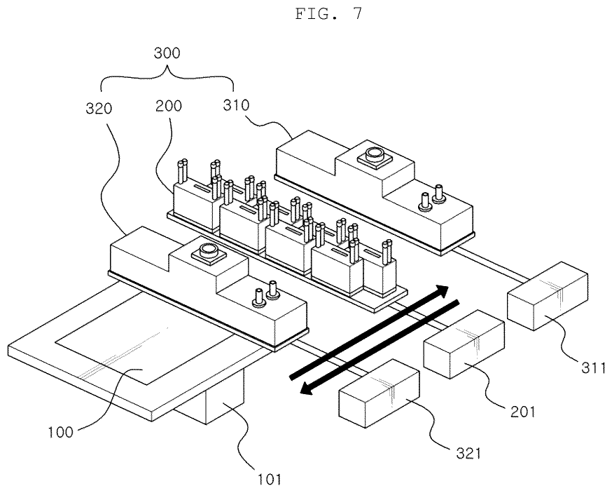

FIG. 6 is a view illustrating a reciprocating printing type of an inkjet printing apparatus according to an embodiment of the present invention.

The inkjet printing apparatus according to an embodiment of the present invention may basically include a substrate which is an object to be printed, a head array module which ejects an ink onto the substrate, and a curing module which cures the ink discharged from the head array module.

Components, which are not separately described, of the inkjet printing apparatus according to the present invention are provided and operated the same as those of a general inkjet printing apparatus, and there is only a difference in arrangement of the head array module and the curing module as described later.

In the present invention, the inkjet printing apparatus may have several arrangements due to the number of each of an inkjet head module and an ultraviolet light curing module, and a proceeding direction of the substrate, an operation time interval of each module, and the like. Specifically, the inkjet printing apparatus may be provided in a reciprocating printing type and a unidirectional printing type.

### First Embodiment Reciprocating Printing Type_Curing Module Simultaneously Operating Type

A reciprocating printing type of the inkjet printing apparatus according to the present invention includes a substrate transfer device 101 that transfers a substrate 100 in a substrate printing direction, a head array module transfer device 201 that transfers a head array module 200, which is installed above the substrate transfer module 100, in the substrate printing direction, and first and second curing modules 310 and 320 installed, respectively, in front of and behind the head array module 200 in the substrate printing direction.

The substrate 100 is defined as one including various objects to be printed, for example, a wafer, a glass substrate, or the like.

The substrate transfer device 101 is installed below the substrate 100 to operate to move the substrate 100 forward and backward in the printing direction.

The substrate transfer device 101 is provided as a known component that is generally installed inside the inkjet printing apparatus, and may be provided as, for example, a linear motor, a linear motion guide, or the like.

The head array module 200 is arranged in a direction perpendicular to the substrate printing direction, and provided so that a plurality of heads h overlap each other to provide an array in the substrate printing direction.

The head array module transfer device 201, which is a known component, is installed to be connected to the head array module 200 inside the inkjet printing apparatus and is provided to operate to move the head array module 200 forward and backward in the substrate printing direction.

The substrate transfer device 101 is provided as a known component that is generally installed inside the inkjet printing apparatus, and may be provided as, for example, a linear motor, a linear motion guide, or the like.

The curing modules include the first curing module 310, which is installed in front of the head array module 200 in the substrate printing direction to cure a thin film printing layer, and the second curing module 320 which is installed behind the head array module 200 in the substrate printing direction to cure a thick film printing layer.

Each of the first and second curing modules 310 and 320 includes a known thermal curing device or light curing device.

In this embodiment, as illustrated in FIG. 6, the first and second curing modules 310 and 320 are provided to be moved simultaneously with the head array module 200 by the head array module transfer device 201.

### Second Embodiment Reciprocating Printing Type_Curing Module Separately Operating Type

FIG. 7 is a view illustrating an embodiment in which a curing module is separately driven in FIG. 6.

In another embodiment of the reciprocating printing type, the curing modules may be provided to include respective transfer devices separately from the head array module transfer device 201 when necessary.

That is, as illustrated in FIG. 7, a first curing module transfer device 311, which transfers the first curing module 310 forward and backward in the substrate printing direction, and a second curing module transfer device 321, which transfers the second curing module 320 forward and backward in the substrate printing direction, may each be provided to operate separately from the head array module transfer device 201.

Each of the first and second curing module transfer devices 311 and 321 is provided as a known component that is generally installed inside the inkjet printing apparatus, and may be provided as, for example, a linear motor, a linear motion guide, or the like.

Each of the reciprocating printing type inkjet printing apparatuses according to the first and second embodiments allows the substrate transfer device 101 to transfer the substrate 100 forward in the substrate printing direction to perform a first printing step (s10) while the substrate 100 moves relative to the head array module 200, and allows the substrate transfer device 101 to transfer the substrate 100 backward in the substrate printing direction to perform a second printing step (s20) while the substrate 100 moves relative to the head array module 200.

Here, the substrate transfer device 101 adjusts a relative transfer speed of the substrate 100 in a reverse direction so that the second printing step (s20) starts after the leveling of the ink discharged in the first printing step (s10) is completed.

Alternatively, the substrate 100 may be fixed, and the head array module transfer device 201 may adjust a relative transfer speed of the head array module 200 in a direction opposite to the substrate printing direction So that the second printing step (s20) starts after the leveling of the ink discharged in the first printing step (s10) is completed.

In the second embodiment in which the first and second curing module transfer devices 311 and 321 are provided separately from the head array module 201, a curing rate or time after the first printing step (s10) and/or the second printing step (s20) may be adjusted through the first and second curing module transfer devices 311 and 321.

### Third Embodiment Unidirectional Printing Type_Two Curing Modules Simultaneously Operating Type

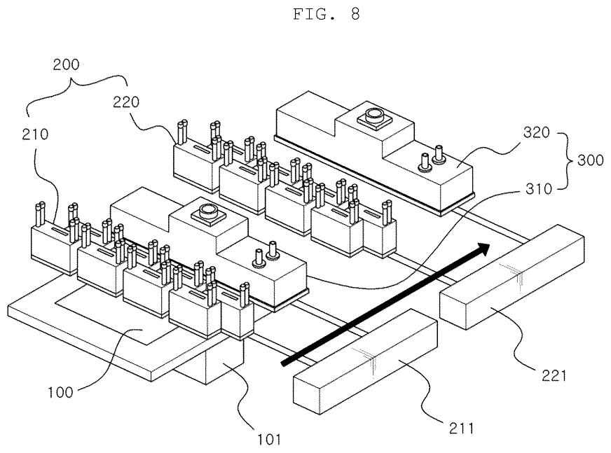

FIG. 8 is a view illustrating unidirectional printing type of an inkjet printing apparatus according to an embodiment of the present invention.

As illustrated in FIG. 8, a unidirectional printing type of an inkjet printing apparatus according to present invention includes a substrate transfer device 101, which transfers a substrate 100 in a substrate printing direction, a first head array module 210, which is installed above the substrate transfer module 100 and at a rear side in the substrate printing direction to perform first printing of printing a thin film printing layer, a second head array module 220, which is installed at the rear side in the substrate printing direction to perform second printing of printing a thick film printing layer, a first curing module 310, which is installed behind the first head array module 220 in the substrate printing direction to cure the thin film printing layer, a second curing module 320, which is installed behind the second head array module 220 in the substrate printing direction to cure the thick film printing layer, a first head array module transfer device 211, which transfers the first head array module 210 and the first curing module 310 at the same time forward and backward in the substrate printing direction, and a second head array module transfer device 221 which transfers the second head array module 220 and the second curing module 330 at the same time forward and backward in the substrate printing direction.

In the third embodiment, two head array modules are spaced a distance from each other in a printing direction so that the printing is performed only in one direction. In this aspect, the third embodiment is distinguished from the first and second embodiments in which only one head array module is provided as the printing direction is a reciprocation direction.

### Fourth Embodiment Unidirectional Printing Type_Ccuring Module Separately Operating Type

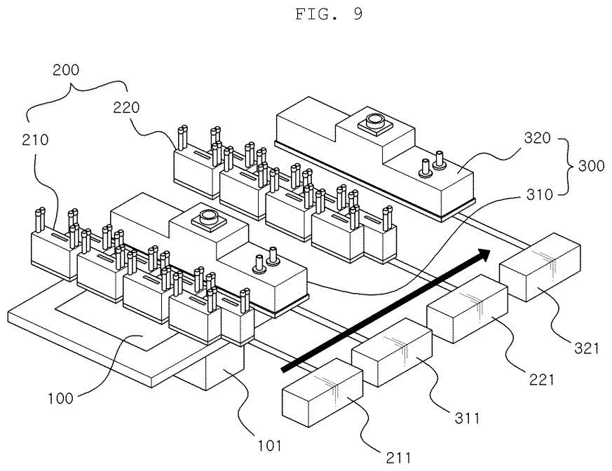

FIG. 9 is a view illustrating an embodiment in which a curing module is separately driven in FIG. 8.

That is, as illustrated in FIG. 9, the fourth embodiment may be provided so that a first head array module transfer device 211 transfers a first head array module 210 alone, a first curing module transfer device 311 which transfers a first curing module 310 forward and backward in the substrate printing direction is separately installed, a second head array module transfer device 221 transfers a second head array module 220 alone, and a second curing module transfer device 321 which transfers a second curing module 320 forward and backward in the substrate printing direction is separately installed.

The fourth embodiment is different from the third embodiment in that the first and second curing modules are operated separately from the first and second head array modules, respectively, and the other components and operations are the same.

### Fifth Embodiment Unidirectional Printing Type One Curing Module Simultaneously Operating Type

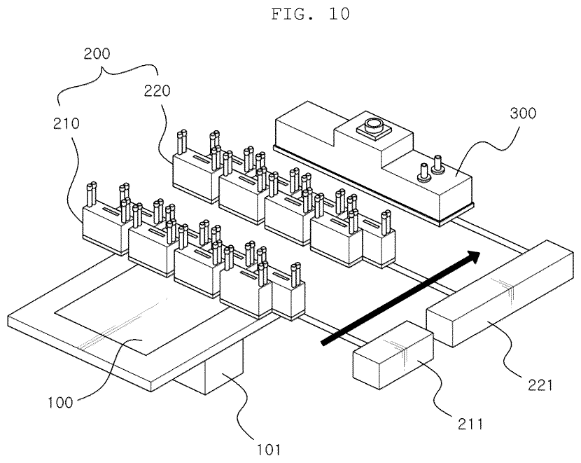

FIG. 10 is a view illustrating a unidirectional printing type of an inkjet printing apparatus according to another embodiment of the present invention.

In the unidirectional printing type of inkjet printing apparatus according to the fifth embodiment of the present invention, only one curing module 300 is installed behind a second head array module 220.

That is, as illustrated in FIG. 10, the inkjet printing apparatus according to the fifth embodiment includes a substrate transfer device 101, which transfers a substrate 100 in a substrate printing direction, a first head array module 210, which is installed above the substrate transfer module 100 and at a rear side in the substrate printing direction to perform first printing of printing a thin film printing layer, a second head array module 220, which is installed at the rear side in the substrate printing direction to perform second printing of printing a thick film printing layer, a first head array module transfer device 211, which transfers the first head array module 210 forward and backward in the substrate printing direction, and a second head array module transfer device 221 which transfers the second head array module 220 and the curing module 300 at the same time forward and backward in the substrate printing direction.

The fifth embodiment is different from the third embodiment only in that the curing module includes only one, but not the first and second curing modules, and the other components and operations are the same.

### Sixth Embodiment_Unidirectional Printing Type One Curing Module Separately Operating Type

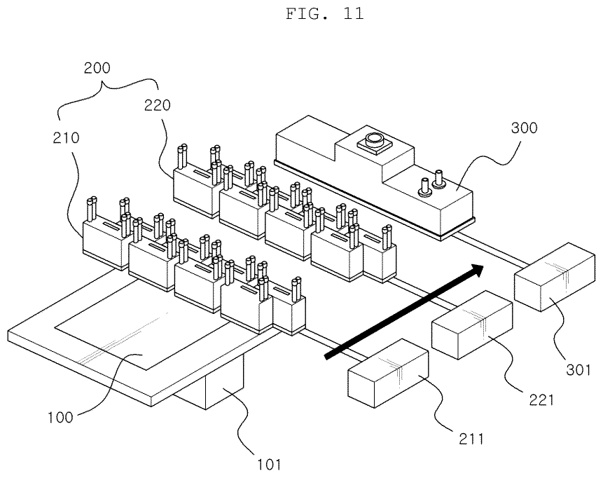

FIG. 11 is a view illustrating an embodiment in which a curing module is separately driven in FIG. 10.

Also in this embodiment, a curing module 300 may be provided to be operated by a separate driving device.

That is, as illustrated in FIG. 11, an inkjet printing apparatus according to the sixth embodiment may be provided so that a second curing module transfer device 321 transfers only a second head array module 220 forward and backward in the substrate printing direction, and a curing module transfer device 301 that transfers the curing module 300 forward and backward in the substrate printing direction is separately installed.

The sixth embodiment is different from the fifth embodiment only in that the curing module 200 may be operated separately from the second head array module 220, and the other components and operations are the same.

Each of the unidirectional printing type inkjet printing apparatuses according to the third to sixth embodiments allows the substrate transfer device 101 to transfer the substrate 100 forward in the substrate printing direction to perform a first printing step (s10) while the substrate 100 moves relative to the first head array module 210, and allows the substrate transfer device 101 to continuously transfer the substrate 100 forward in the substrate printing direction to perform a second printing step (s20) while the substrate 100 moves relative to the second head array module 220.

The second printing step (s20) may be designed to start after leveling of an ink discharged in the first printing step (s10) is completed.

Thus, a distance between the first head array module 210 and the second head array module 220 may be determined to be suitable to the applied ink leveling time on the basis of a general transfer speed of the substrate transfer device 101.

Alternatively, like the case in FIG. 8, the transfer speed of the substrate transfer device 101 is adjusted so that the substrate 200 approaches to the second head array module 220 after the leveling of the ink discharged by the first head array module 210 in the first printing step (s10) is completed.

Alternatively, the substrate 100 may be fixed, and the second head array module transfer device 220 may adjust a relative speed of the second head array module 220 to the first head array module 210 in the substrate printing direction so that the second printing step (s20) starts after the leveling of the ink discharged in the first printing step (s10) is completed.

Meanwhile, in the fourth embodiment in which the first and second curing module transfer devices 311 and 321 are provided separately from the first and second head array module transfer devices 211 and 221, a curing rate or time after the first printing step (s10) or the second printing step (s20) may be adjusted through the first and second curing module transfer devices 311 and 321.

In addition, in the sixth embodiment in which the curing module transfer device 301 is provided separately from the second head array module transfer device 221, a curing rate or time after the second printing step may be adjusted through the curing module transfer device 301.

Inkjet printing method

An inkjet printing method using the inkjet printing apparatus according to the present invention is as follows.

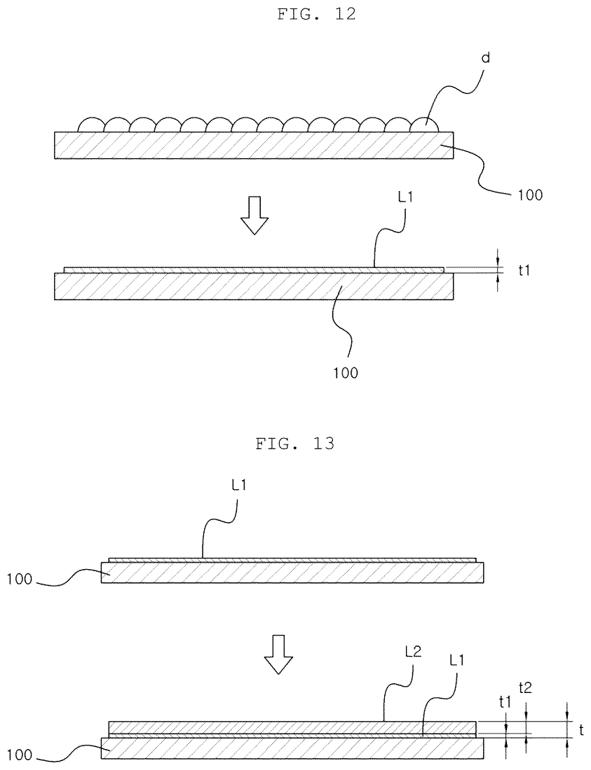

FIG. 12 is a view illustrating a first printing step of an inkjet printing method according to the present invention.

A thickness t of a thick film layer L printed through the inkjet printing method according to the present invention means generally having a large thickness (t=t1+t2) of 20 μm or more.

First, a first printing step (s10) is performed of forming a thin film printing layer L1 having a thickness t1 on a substrate 100 by discharging an ink in an amount in which ink droplets d deposited on the substrate 100 overlap each other to print a thin film coating having a uniform thickness.

In the first printing step (s10), only when the ink droplets d discharged on the substrate 100 are formed to overlap each other, attraction between the ink droplets d enables the thin film printing layer L1 having a uniform thickness to be formed throughout the surface.

In the first printing step (s10), as illustrated in FIG. 12, the ink droplets d discharged on the substrate 100 to overlap each other undergo a leveling process as a certain time passes so that a height of the thin film printing layer L1 becomes uniform as a whole.

Due to this action, the thin film printing layer formed in the first printing step (s10) is formed to have more uniform surface tension than surface tension of the substrate 100 by the ink.

In the first printing step (s10), leveling time for the ink droplets depends on fundamental attributes of the ink, and is determined according to characteristics of the ink.

In general, the thickness t1 of the thin film printing layer L1 in the first printing step (s10) is 0.08 t to 0.3 t.

That is, in the first printing step (s10), a layer having a small thickness that is 0.8% to 30% of a desired thickness t of the thick film layer L is first printed to obtain a leveled coating layer in which a stain between the heads, which is generated when 100% thickness printing is performed solely by the first printing, or a stain caused by a thickness difference is not generated.

FIG. 13 is a view illustrating a second printing step of an inkjet printing method according to the present invention.

Next, a second printing step (s20) is performed of forming a thick film printing layer L2 having a thickness (t2=t-−t1) by discharging an ink in an amount to print a thick film coating having a uniform thickness to overlap on the thin film printing layer L1.

The thickness (t−-t1) of the thick film printing layer L2 in the second printing step (s20) is 0.992 t to 0.7 t.

The second printing step (s20) is performed after a time period of leveling the ink droplets discharged in the first printing step (s10).

An inkjet ejection amount is primarily obtained by using an area and thickness to be printed, and as contraction of an ink occurs through ultraviolet curing, this is complemented to finally determine the ejection amount.

A contraction rate is obtained by measuring an initially discharged ink amount and calculating a difference with a volume measured after curing the ink using an ultraviolet curing device.

As above, in the second printing step (s20), when a lot of ink droplets are discharged to form the thick film layer, first discharged ink droplets are first held by the thin film printing layer formed in the first printing to prevent a phenomenon in which next discharged ink droplets attract the first discharged ink droplets to lead ink gathering.

Accordingly, there is an action effect of preventing occurrence of a stain between the heads caused by a position difference between the heads in the first row and the second row.

In addition, a phenomenon in which ink droplets are gathered to cause a thickness difference to be visible is prevented due to a difference in surface tension on the surface of the substrate 100.

In the inkjet printing method according to the present invention, the thick film printing layer L2 is formed to overlap a printing region in which the thin film printing layer L1 is i formed, and thus, the thick film printing layer L2 is printed and cured only at a position at which the thin film printing layer L1 is formed.

Accordingly, due to the surface tension of the ink formed on the thin film printing layer L1, the edge spreading does not occur even after the thick film printing layer L2 is discharged.

Thus, as a separate edge height-increasing printing process is not additionally performed to prevent the edge spreading unlike the related art, there is an advantage that the number of processes is reduced.

This advantage is more effective in that a separate edge height-increasing process is unnecessary even when a thick layer is formed not in a linear shape but in a curved shape, particularly at a rounded portion of an edge of a smartphone, or around a camera hole of the smartphone.

The reciprocating printing type inkjet printing apparatus according to the present invention performs the first printing step (s10) in one direction in the substrate printing direction, and performs the second printing step (s20) reversely in the substrate printing direction after the time period of the leveling passes.

In the reciprocating printing type inkjet printing apparatus, a process time required for the first and second printing is a time for reciprocating the substrate 100.

In the other hand, in the unidirectional printing type inkjet printing apparatus according to the present invention, the printing operation is completed even when the substrate 100 moves only in one direction of the printing direction.

Thus, in the unidirectional printing type inkjet printing apparatus, a process time required for the first and second printing is a time for unidirectionally transferring the substrate 100, and thus there is an advantageous effect in the aspect of improvement in productivity.

In order to form the thick film printing layer, the size of the ink droplet in the second printing step (s20) may be greater than or equal to the size of the ink droplet in the first printing step (s10).

Alternatively, in order to form the thick film printing layer, a plurality of ink droplets may be discharged by one signal at the same time or continuously in the second printing step (s20) so that the ink is discharged in an amount greater than an amount of the ink discharged in the first printing step (s30).

The ink applied in the second printing step (s20) is the same ink or an ink having the same surface tension as the ink applied in the first printing step (s10).

When the thickness t of the thick film layer is formed to be greater, only the second printing step (s20) may be additionally continuously performed.

The inkjet printing apparatus according to the present invention includes a curing step s30.

In the reciprocating printing type inkjet printing apparatus, the ink curing step (s30) includes a thin film printing layer curing step (s31) of curing the thin film printing layer at the front side in the substrate printing direction in the first printing step (s30), and a thick film printing layer curing step (s32) of curing the thick film printing layer at the rear side in the substrate printing direction in the second printing step (s30).

In the unidirectional printing type inkjet printing apparatus, the curing step (s30) includes a thin film printing layer curing step (s31) of curing the thin film printing layer at the front side in the substrate printing direction in the first printing step (s30), and a thick film printing layer curing step (s32) of curing the thick film printing layer at the front side in the substrate printing direction in the second printing step (s30).

A temporal or complete curing step for the first printing may be selectively performed when necessary.

The curing step for the second printing is fundamentally included, and particularly, the second printing curing step may be applied to the entirety of the thick film printing layer L2 including the edge or applied to at least the edge of the thick film printing layer L2.

As the curing step is applied to at least the edge of the thick film printing layer, the present invention has an effect that an additional printing process of increasing the edge height to prevent the ink spreading on the edge is unnecessary unlike the related art.

Although the preferred embodiments of the present invention have been described, it will be apparent to those skilled in the art that the present invention is not limited to the embodiments set forth herein, and may be embodied in different forms without departing from the spirit and scope of the present invention.

1. An inkjet printing method for forming a thick film layer having a thickness (t) on a substrate by using an inkjet printing apparatus comprising a head module configured to discharge an ink, the method comprising:
a first printing step of forming a thin film printing layer having a thickness (t1) on the substrate by discharging the ink in an amount to allow ink droplets deposited on the substrate to overlap and attract each other to print a thin film coating having a uniform thickness; and
a second printing step of forming a thick film printing layer having a thickness (t2=t−t1) by discharging an ink in an amount in which a thick film coating having a uniform thickness is printed to overlap on the thin film printing layer.

2. The inkjet printing method of claim 1, wherein the second printing step is performed after a time period of leveling the ink droplets discharged in the first printing step.

3. The inkjet printing method of claim 2, wherein the first printing step is performed while the substrate relatively moves in one direction of a substrate printing direction, and the second printing step is performed while the substrate relatively moves in an opposite direction to the one direction of the substrate printing direction.

4. The inkjet printing method of claim 3, further comprising an ink curing step of curing the printed ink, wherein the ink curing step comprises:
a thin film printing layer curing step of curing the thin film printing layer at a front side in the substrate printing direction in the first printing step; and a thick film printing layer curing step of curing the thick film printing layer at a rear side in the substrate printing direction in the first printing step.

5. The inkjet printing method of claim 4, wherein, in the thick film printing layer curing step at least an edge portion of the thick film printing layer is cured to prevent non-uniform ink spreading on an edge of the thick film printing layer when the second printing step is performed.

6. The inkjet printing method of claim 2, wherein the first printing step and the second printing step are performed at positions spaced apart from each other in the substrate printing direction.

7. The inkjet printing method of claim 6, further comprising an ink curing step of curing the printed ink, wherein the ink curing step comprises:
a thin film printing layer curing step of curing the thin film printing layer at a front side in the substrate printing direction in the first printing step; and
a thick film printing layer curing step of curing the thick film printing layer at the front side in the substrate printing direction in the second printing step.

8. The inkjet printing method of claim 7, wherein, in the thick film printing layer curing step at least an edge portion of a printing region is cured to prevent non-uniform ink spreading on an edge of the thick film printing layer during the printing in the second printing step

9. The inkjet printing method of claim 6, further comprising an ink curing step of curing the printed ink at the rear side in the substrate printing direction in the second printing step.

10. The inkjet printing method of claim 1, wherein a size of each of the ink droplets in the second printing step is greater than or equal to a size of each of the ink droplets in the first printing step

11. The inkjet printing method of claim 1, wherein a plurality of ink droplets are discharged by one signal at the same time or continuously in the second printing step so that the ink is discharged in an amount greater than an amount of the ink discharged in the first printing step.

12. The inkjet printing method of claim 1, wherein the ink applied in the second printing step is the same ink or an ink having the same surface tension as the ink applied in the first printing step.

13. The inkjet printing method of claim 1, wherein only the second printing step is additionally performed to increase the thickness (t) of the thick film layer.

14. The inkjet printing method of claim 1, wherein the thickness (t1) of the thin film printing layer in the first printing step is 0.08 t to 0.3 t, and the thickness (t2) of the thick film printing layer in the second printing step is 0.992 t to 0.7 t.

15. An inkjet printing apparatus for providing a thick film layer having a thickness (t) on a substrate, the inkjet printing apparatus comprising:
a head array module installed above the substrate to discharge an ink on the substrate,
wherein the head array module is arranged in a direction perpendicular to a substrate printing direction, and provided so that a plurality of heads overlap each other to form an array in the substrate printing direction,
wherein the inkjet printing apparatus is configured to perform:
a first printing step of forming a thin film printing layer having a thickness (t1) on the substrate by discharging an ink in an amount in which ink droplets, which are sprayed from the head array module to be deposited on the substrate while the substrate moves relative to the head array module in the substrate printing direction, attract each other so as to print a thin film coating having a uniform thickness; and
a second printing step of forming a thick film printing layer having a thickness (t2=t−t1) by allowing the head array module to discharge an ink in an amount to print a thick film coating having a uniform thickness to overlap on the thin film printing layer, while the substrate moves relative to the head array module in a direction opposite to the substrate printing direction.

16. The inkjet printing apparatus of claim 15, further comprising a substrate transfer device configured to control a transfer speed of the substrate so that the second printing step is performed after leveling of the ink discharged in the first printing step is completed.

17. The inkjet printing apparatus of claim 15, further comprising a head array module transfer device configured to control a transfer speed of the head array module so that the second printing step is performed after leveling of the ink discharged in the first printing step is completed.

18. The inkjet printing apparatus of claim 16, further comprising a curing module configured to cure the thick film layer, wherein the curing module comprises:
a first curing module installed in front of the head array module in the substrate printing direction to cure the thin film printing layer; and
a second curing module installed behind the head array module in the substrate printing direction to cure the thick film printing layer,
wherein the first and second curing modules are provided to be moved simultaneously with the head array module forward and backward in the substrate printing direction by the substrate transfer device.

19. The inkjet printing apparatus of claim 16, further comprising a curing module configured to cure the thick film layer, wherein the curing module comprises:
a first curing module installed in front of the head array module in the substrate printing direction to cure the thin film printing layer; and
a second curing module installed behind the head array module in the substrate printing direction to cure the thick film printing layer,
wherein the inkjet printing apparatus comprises first and second curing module transfer devices which are installed to be, respectively, connected to the first curing module and the second curing module to transfer the first and second curing modules forward and backward in the substrate printing direction separately from the substrate transfer module.

20. An inkjet printing apparatus for providing a thick film layer having a thickness (t) on a substrate, the inkjet printing apparatus comprising:
two head array modules, each of which is installed above the substrate to discharge an ink on the substrate,
wherein the head array modules are arranged in a direction perpendicular to a substrate printing direction, and provided so that a plurality of heads overlap each other to form an array in the substrate printing direction,
wherein the head array modules comprise a first head array module installed at a rear side in the substrate printing direction, and a second head array module installed behind the first head array module in the substrate printing direction,
wherein the inkjet printing apparatus is configured to perform:
a first printing step of forming a thin film printing layer having a thickness (t1) on the substrate by discharging an ink in an amount in which ink droplets, which are sprayed from the first head array module to be deposited on the substrate while the substrate moves relative to the head array module in the substrate printing direction, attract each other so as to print a thin film coating having a uniform thickness; and
a second printing step of forming a thick film printing layer having a thickness (t2=t−t1) by allowing the second head array module to discharge an ink in an amount to print a thick film coating having a uniform thickness to overlap on the thin film printing layer.

21. The inkjet printing apparatus of claim 20, further comprising a substrate transfer device configured to control a transfer speed of the substrate so that the second printing step is performed after leveling of the ink discharged in the first printing step is completed.

22. The inkjet printing apparatus of claim 20, further comprising first and second head array module transfer devices which are installed to be, respectively, connected to the first head array module and the second head array module to transfer the first and second head array modules forward and backward in the substrate printing direction,
wherein the second head array module transfer device adjusts a relative transfer speed of the second head array module to the first head array module so that the second printing step is performed after leveling of the ink discharged in the first printing step is completed.

23. The inkjet printing apparatus of claim 20, wherein a distance between the first head array module and the second first head array module is set so that the second printing step starts when a time period of leveling the ink is completed after the first printing is finished at a transfer speed of the substrate transfer device

24. The inkjet printing apparatus of claim 23, further comprising a curing module configured to cure the thick film layer, wherein the curing module comprises:
a first curing module installed behind the first head array module in the substrate printing direction to cure the thin film printing layer; and
a second curing module installed behind the second head array module in the substrate printing direction to cure the thick film printing layer,
wherein the first head array module and the first curing module are provided to be moved by the first head array module transfer device forward and backward in the substrate printing direction, and
the second head array module and the second curing module are provided to be moved by the second head array module transfer device forward and backward in the substrate printing direction.

25. The inkjet printing apparatus of claim 23, further comprising a curing module configured to cure the thick film layer, wherein the curing module comprises:
a first curing module installed behind the first head array module in the substrate printing direction to cure the thin film printing layer; and
a second curing module installed behind the second head array module in the substrate printing direction to cure the thick film printing layer,
wherein the inkjet printing apparatus comprises first and second curing module transfer devices which are installed to be, respectively, connected to the first curing module and the second curing module to transfer the first and second curing modules forward and backward in the substrate printing direction separately from the first and second substrate transfer devices.

26. The inkjet printing apparatus of claim 23, further comprising a curing module configured to cure the thick film layer,
wherein the curing module is installed behind the second head array module in the substrate printing direction,
wherein the curing module and the second head array module are provided to be moved forward and backward in the substrate printing direction by the second head array module transfer device.

27. The inkjet printing apparatus of claim 23, further comprising a curing module configured to cure the thick film layer,
wherein the curing module is installed behind the second head array module in the substrate printing direction, and is installed to be connected to the curing module to transfer the curing module forward and backward in the substrate printing direction separately from the first and second substrate transfer devices.
